(19) United States
(12) Patent Application Publication
(10) Pub. No.: US 2026/0097546 A1
(43) Pub. Date: Apr. 9, 2026

(54) CLOSING UNIT FOR A MOLDING MACHINE

(71) Applicant: ENGEL AUSTRIA GmbH, Schwertberg (AT)

(72) Inventors: Christoph BALKA-HINTERSTEINER, Schwertberg (AT); Gerhard Hackl-Lehner, St. Thomas/BI. (AT); Klaus Maximilian Riegler, Grein (AT); Johannes Leonhard Krondorfer, Linz (AT)

(21) Appl. No.: 19/347,977

(22) Filed: Oct. 2, 2025

(30) Foreign Application Priority Data
Oct. 3, 2024 (AT) A 50802/2024

(51) Int. Cl. B29C 45/67

(52) U.S. Cl. CPC B29C 45/67

(57) ABSTRACT

A closing unit for a molding machine includes a movable mold mounting plate, a fast-stroke device configured to displace the movable mold mounting plate relative to a fixed mold mounting plate, and a closing force mechanism separate from the fast-stroke device and designed to build up a closing force between the fixed mold mounting plate and the movable mold mounting plate. The fast-stroke device is arranged substantially coaxially to a central longitudinal axis of the closing unit.

### BACKGROUND OF THE INVENTION

The present invention relates to a closing unit for a molding machine, as well as a molding machine with such a closing unit. Molding machines can include injection molding machines, injection presses, presses and the like. Molding machines in which the plasticized molding mass is fed into an open mold are also quite conceivable.

In the following, the prior art shall be outlined in the case of an injection molding machine. This analogously applies generally to molding machines.

Generic closing units for injection molding machines comprise:
a movable mold mounting plate,
a fast-stroke device which is designed to displace the movable mold mounting plate relative to a fixed mold mounting plate, and
a closing force mechanism separate from the fast-stroke device, which is designed to build up a closing force between the fixed mold mounting plate and the movable mold mounting plate.

In known embodiments of the prior art, it is customary to arrange a closing force mechanism in such a way that a resulting closing force coincides with the central longitudinal axis of the closing unit, so that a mold arranged between the fixed mold mounting plate and the movable mold mounting plate is loaded symmetrically by the closing force. Such an alignment is particularly necessary because, given the very high closing forces exerted, an asymmetrical introduction of force into the mold would lead to the mold opening, which would have a negative impact on the molded parts to be produced and their quality.

Due to this feature, it is necessary to arrange the closing force mechanism coaxially to a central longitudinal axis of the closing unit, which makes it necessary to relocate the fast-stroke device to an eccentric position due to lack of space.

This fast-stroke device is used to carry out a relative movement of the movable mold mounting plate relative to the fixed mold mounting plate, wherein the mold halves of a mold arranged on the mold mounting plates must be distanced from each other as quickly as possible in order to be able to remove produced molded parts from the mold cavities and then quickly place the mold halves back together in order to produce another batch of molded parts in a subsequent injection molding process.

As can be concluded, the fast-stroke device is a crucial aspect regarding the productivity of an injection molding machine, wherein productivity can also be increased by increasing the speeds.

However, this presents known embodiments of closing units, in particular two-plate closing units with C-frames (as shown, for example, in EP 0 894 605 A1), with a technical challenge, since the high acceleration and deceleration movements of the fast-stroke device result in corresponding reaction forces due to the inertial forces.

For example, accelerating a moving mold mounting plate by means of a fast-stroke device, which is arranged in the machine frame and acts eccentrically on the moving mold mounting plate, thus leads to high tilting moments on the moving mold mounting plate.

These tilting moments in turn place a load on the guides or the guide of the movable mold mounting plate on the machine frame, which means that this guide or these guides must be additionally reinforced in order to withstand the increased stresses of the opening and/or closing movement of the movable mold mounting plate. Nevertheless, the guides are subject to wear and tear, which causes the guide to lose its accuracy and functionality over time.

Such a restriction of the accuracy or functionality of the guidance of the movable mold mounting plate in turn leads to a less accurate positioning of the movable mold mounting plate relative to the fixed mold mounting plate, as well as an ever increasing tilting of the movable mold mounting plate during the closing and/or opening movement, which in turn is reflected in a reduction in the quality of the molded workpieces produced.

### SUMMARY OF THE INVENTION

The object of the present invention is to provide a closing unit for a molding machine, as well as a molding machine with such a closing unit, in which the previously described disadvantages of the prior art are at least partially improved and/or less wear and/or less stress on the guides of the movable mold mounting plate can be implemented.

This object is achieved by a closing unit for a molding machine as described below, as well as a molding machine with such a closing unit.

According to the invention, a closing unit for a molding machine comprises:
a movable mold mounting plate,
a fast-stroke device which is designed to displace the movable mold mounting plate relative to a fixed mold mounting plate, and
a closing force mechanism separate from the fast-stroke device, which is designed to build up a closing force between the fixed mold mounting plate and the movable mold mounting plate,
wherein the fast-stroke device is arranged substantially coaxially to a central longitudinal axis of the closing unit.

Due to the essentially coaxial arrangement of the fast-stroke device to a central longitudinal axis of the closing unit, an essentially central introduction of the fast-stroke movement into the movable mold mounting plate can be implemented.

Consequently, a tilting movement triggered by the initiation of the fast-stroke movement can be completely avoided or excluded by an embodiment variant according to the invention, since no or only very small moments are generated on the movable mold mounting plate by the initiation of the fast-stroke movement coaxial to a central longitudinal axis.

Molding machines can include injection molding machines, injection presses, presses and the like. Molding machines in which the plasticized molding mass is fed into an open mold are also quite conceivable.

In the context of this document, when a plate is mentioned, it does not necessarily mean a flat, planar plate. The plate can also have recesses, elevations and a concave machining of the mounting surface for optimal closing force distribution when closed. Designs with ribs, webs, especially connecting webs or struts with pressure pads, or other structures for stabilization or deformation optimization are also conceivable.

The central longitudinal axis can be formed parallel to the travel path and/or the closing force direction.

“Substantially coaxial” can be understood, for example, to mean that the central longitudinal axis intersects a force introduction point of the movable mold mounting plate.

In this context, the force introduction point of the movable mold mounting plate is to be seen as the central introduction point of a resulting closing force to which the movable mold mounting plate is subjected. In other words, the force introduction point is the center of the points at which the closing force mechanism introduces the closing force into the fixed mold mounting plate and/or the movable mounting plate, with each point being weighted according to the force introduced at the respective position.

The movable mold mounting plate can be designed with a symmetrical mounting surface for receiving a mold half.

A coaxial arrangement of the fast-stroke device relative to the central longitudinal axis can be understood, for example, to mean that the central longitudinal axis intersects the point of symmetry of the mounting surface, preferably orthogonal to the mounting surface. The central longitudinal axis may be aligned substantially coaxially with the resulting total closing force (e.g. resulting from the closing force mechanism).

The central longitudinal axis intersects a center of mass of the movable mold mounting plate.

Preferably, the relative movement of the movable mold mounting plate to the fixed mold mounting plate runs parallel to the central longitudinal axis.

“Substantially coaxial” can, for example, be interpreted such that the distance between the central longitudinal axis and the fast-stroke axis (and/or the resulting total closing force) is less than 10%, preferably less than 5%, particularly preferably less than 2%, of the radial distance of the longitudinal axis to the nearest pressure pad.

Preferably, the fast-stroke device has a, in particular hydraulic, piston-cylinder unit, wherein a cylinder of the piston-cylinder unit is arranged substantially coaxially to the central longitudinal axis.

The fast-stroke device has a spindle drive, wherein a rotation axis of the spindle and/or the recirculating ball nut of the spindle drive is arranged substantially coaxially to the central longitudinal axis.

Preferably, the spindle drive is supported on the one hand on a machine frame of the closing unit and on the other hand on a fast-stroke element, which fast-stroke element is preferably connected to the movable mold mounting plate by means of connecting rods.

Preferably, the spindle drive is supported on the one hand on a machine frame of the closing unit via the spindle and on the other hand on a fast-stroke element via the spindle nut, which fast-stroke element is preferably connected to the movable mold mounting plate by means of connecting rods.

By using a fast-stroke element which is connected to the movable mold mounting plate via connecting rods, the fast-stroke movement can then be transmitted to the movable mold mounting plate, wherein a central region of the movable mold mounting plate is freed up (despite the central transmission of the fast-stroke movement) in order, for example, to be able to arrange an ejector mechanism on the movable mold mounting plate in this free space.

At least one ejector drive can be connected to the fast-stroke element, which at least one ejector drive preferably comprises at least one hydraulic piston-cylinder unit.

An ejector mechanism is used to safely remove a molded part that is still attached to one of the mold halves from the mold half after the mold halves of a mold of a molding machine have been opened (by opening the closing unit).

Preferably, the closing force mechanism has at least two pressure pads, wherein the pressure pads are arranged symmetrically to the central longitudinal axis. Designs with four or six pressure pads are also conceivable. For example, viewed in a plane transverse to the longitudinal axes of the two connecting rods and/or the movement axes of the two pressure pads, the longitudinal axes and the movement axes form the corner points of a rhombus.

Preferably, each of the at least two pressure pads is connected by at least one strut to a partial region of the movable mold mounting plate forming a mounting surface, wherein the struts each have a strut longitudinal axis, which preferably run parallel in a view transverse to the central longitudinal axis.

The strut longitudinal axes can, for example, be arranged asymmetrically relative to the central longitudinal axis in a view transverse to the central longitudinal axis, in particular wherein the strut longitudinal axes of the strut further away from the machine frame have a greater distance from the central longitudinal axis that is between 1% and 10%, preferably between 2.5% and 7.5%, particularly preferably 5%.

The at least two pressure pads can be designed as hydraulic piston-cylinder units, wherein the cylinders of the piston-cylinder units are formed integral with the movable mold mounting plate.

Preferably, the closing force mechanism, preferably at least one of the at least two pressure pads, particularly preferably at least one of the at least two cylinders of the at least two pressure pads, is connected by at least one strut to a base body of the movable mold mounting plate forming a mounting surface. The at least one strut can also be regarded as a connecting web, for example.

At least two subcomponents of the closing force mechanism, preferably at least two pressure pads of the closing force mechanism, particularly preferably at least two cylinders of the at least two pressure pads, can be connected to one another via a yoke, in particular spaced apart from a base body of the movable mold mounting plate forming the mounting surface.

For example, the at least two cylinders of the at least two pressure pads can be connected to one another via a yoke spaced from the base body of the movable mold mounting plate forming the mounting surface.

The yoke, the at least one strut, the connecting web, and the base body of the movable mold mounting plate forming the mounting surface can be formed in one piece, preferably as a cast or welded construction. Preferably, all pressure pads or a portion of the provided pressure pads are connected to one another via the yoke.

The yoke can, for example, form a further base body of the movable mold mounting plate, which preferably extends substantially parallel to the base body of the movable mold mounting surface forming the mounting surface, particularly preferably which is connected to the base body of the movable mold mounting plate forming the mounting surface by means of at least one strut and/or at least one connecting web.

Preferably, the fast-stroke device can be connected via the yoke to the closing force mechanism, in particular to at least one pressure pad of the closing force mechanism. The fast-stroke device is connected, preferably via a connection to a yoke, to at least one of the at least two cylinders of the at least two pressure pads.

Preferably, the at least two pressure pads, in particular each of the at least two pressure pads, cooperate with a push rod, which push rod is particularly preferably supported on a machine frame of the closing unit via a locking nut. The locking nut cooperating with the push rod can be designed as a split locking nut, which can preferably carry out an opening and/or closing movement via a purely translational movement.

The machine frame of the molding machine can be designed as a C-frame on which the movable mold mounting plate is movably mounted by a sliding guide.

Preferably, the closing unit is designed as a column-free closing unit and/or a 2-plate closing unit.

Furthermore, protection is sought for a molding machine, in particular an injection molding machine, with at least one corresponding closing unit.

### BRIEF DESCRIPTION OF THE DRAWINGS

Further details and advantages of the present invention will be explained in more detail below with reference to the drawings, in which:

FIG. 1 shows a first exemplary embodiment of a closing unit in a perspective view,

FIG. 2 shows the exemplary embodiment of FIG. 1 in a further perspective view,

FIG. 3 shows the fast-stroke device from FIGS. 1 and 2 in isolation,

FIG. 4 shows a second exemplary embodiment of a closing unit,

FIG. 5 shows a third exemplary embodiment of a closing unit,

FIG. 6 shows another exemplary embodiment of a mold mounting plate,

FIG. 7 shows the exemplary embodiment of FIG. 6 in a sectional view,

FIG. 8 shows the mold mounting plate from FIGS. 6 and 7 in isolation,

FIG. 9 shows the mold mounting plate from FIGS. 6 to 9 in a further perspective view in isolation,

FIG. 10 shows the mold mounting plate from FIGS. 6 to 9 in a plan view,

FIG. 11 shows section A-A marked in FIG. 10,

FIG. 12 shows section B-B marked in FIG. 10, and

FIG. 13 shows a further exemplary embodiment of a closing unit.

### DETAILED DESCRIPTION OF THE INVENTION

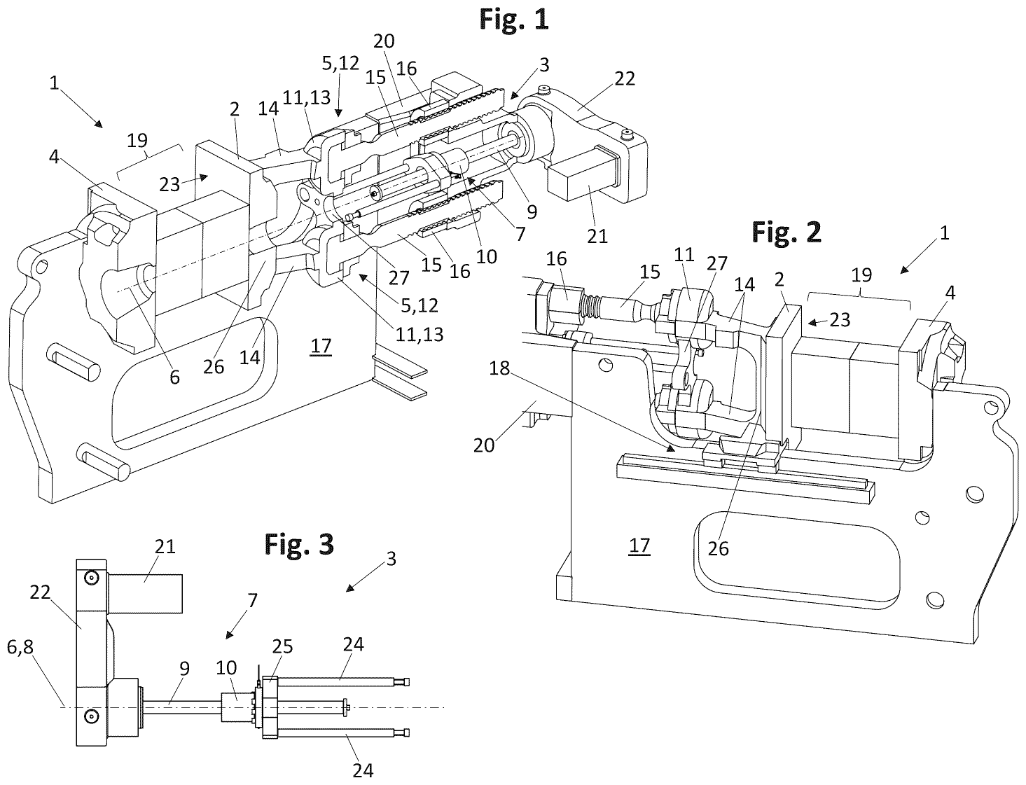

FIGS. 1 and 2 show a first exemplary embodiment of a closing unit 1 in different perspective views.

In the views of FIGS. 1 and 2, the closing unit 1 has been cut through a vertical plane spanned by the central longitudinal axis 6 to improve visibility.

It can be seen that the closing unit 1 has a machine frame 17. On this machine frame 17, on the one hand, the fixed mold mounting plate 4 is mounted, and on the other hand, the movable mold mounting plate 2 is mounted via the sliding guides 18. The movable mold mounting plate 2 is mounted displaceably relative to the fixed mold mounting plate 4 parallel to the central longitudinal axis 6.

The sliding guides 18 of the movable mold mounting plate 2 are implemented by a sliding rail—which is mounted on the machine frame 17—and sliding shoes guided thereon (which are connected to the movable mold mounting plate 2). A mold 19 is mounted between the movable mold mounting plate 2 and the fixed mold mounting plate 4, wherein a mold half of the mold 19 is arranged on each one of the mounting surfaces 23 of the fixed mold mounting plate 4 and the movable mold mounting plate 2.

Furthermore, the closing unit 1 comprises a fast-stroke device 3, which is designed to displace the movable mold mounting plate 2 relative to the fixed mold mounting plate 4. In this exemplary embodiment, this fast-stroke device 3 is implemented by a spindle drive 7.

For a more detailed explanation of the fast-stroke device 3, reference is made to FIG. 3, which shows the fast-stroke device 3 in isolation. The fast-stroke device 3 comprises a central spindle drive 7, which comprises a spindle 9 and a recirculating ball nut 10 cooperating therewith. The spindle 9 can be driven about the rotation axis 8 by means of an electric drive unit 21 and a gear 22. Alternatively, versions with a hydraulic or pneumatic drive unit are also conceivable.

Due to the rotational movement of the spindle 9 around the rotation axis 8, the recirculating ball nut 10 on the spindle 9 can be driven translationally along the rotation axis 8. The recirculating ball nut 10 is rigidly connected to the link bridge 25 by a screw connection, wherein the link bridge 25 is in turn rigidly connected to the two link rods 24.

The link rods 24 are in turn—as can be seen from FIGS. 1 and 2—connected to the movable mold mounting plate 2, whereby a displacement of the recirculating ball nut 10 along the central longitudinal axis 6 can be transferred directly to the movable mold mounting plate 2 via the rotational movement of the spindle 9 about the rotation axis 8.

The rotation axis 8 of the spindle 9 and/or the spindle drive 7 is concentric to the central longitudinal axis 6. The spindle drive 7 is supported via the support plate 20 on the machine frame 17 of the closing unit 1. In this embodiment, the support plate 20 is screwed to the machine frame.

By this fast-stroke device 3, the movable mold mounting plate 2 can be lifted from the fixed mold mounting plate 4, for example in order to release a produced molded part for removal or to insert an insert into the mold 19. The movable mold mounting plate 2 can then be moved closer to the fixed mold mounting plate 4 via the fast-stroke device 3 until the mold halves of the mold 19 close. After closing the mold 19, a closing force is exerted on the mold 19 between the fixed mold mounting plate 4 and the movable mold mounting plate 2 via the closing force mechanism 5, which is formed separately from the fast-stroke device 3.

In the exemplary embodiment of FIGS. 1 and 2, the closing force mechanism 5 comprises four pressure pads 11, wherein only two pressure pads 11 are visible in FIGS. 1 and 2 due to the sectional view. These pressure pads 11 are implemented as hydraulic piston-cylinder units 12, wherein the cylinder of these piston-cylinder units 12 of the pressure pads 11 is formed integrally with the movable mold mounting plate 2.

In this embodiment, the cylinders 13 of the pressure pads 11 are connected to each other via the yoke 27, with the linkage rods 24 of the fast-stroke device 3 being connected to this connection. The cylinders 13 of the pressure pads 11 are further connected via the strut 14 to the base body 26 of the movable mold mounting plate 2 forming the mounting surface 23.

This design of the movable mold mounting plate 2 with the strut 14 allows a certain elastic deformability, which makes it possible to implement plate parallelism between the movable mold mounting plate 2 and the fixed mold mounting plate 4 even in the case of an asymmetrical closing force due to an asymmetrically arranged mold 14 or an asymmetrical pressure distribution. The pistons of the piston-cylinder units 12 of the pressure pads 11 are represented by the push rods 15. These push rods 15 can be connected to the support plate 20 and thus to the machine frame 17 via split locking nuts 16.

When the mold 19 is now closed via the fast-stroke device 3, the push rods 15 are locked to the support plate 20 and thus to the machine frame 17 via the split locking nuts 16. After locking the push rods 15, a pressure is built up in the pressure pads 11—more precisely: the piston-cylinder units—which exerts a compressive force—more precisely: a closing force—between the movable mold mounting plate 2 and the fixed mold mounting plate 4 on the mold 19 via the strut 14.

A design of the movable mold mounting plate 2 with pressure pads 11 spaced apart by the strut 14 further provides the advantage that a free space is created between the connecting struts 14, which is suitable for accommodating an ejector mechanism (which is not shown in the figures for reasons of clarity).

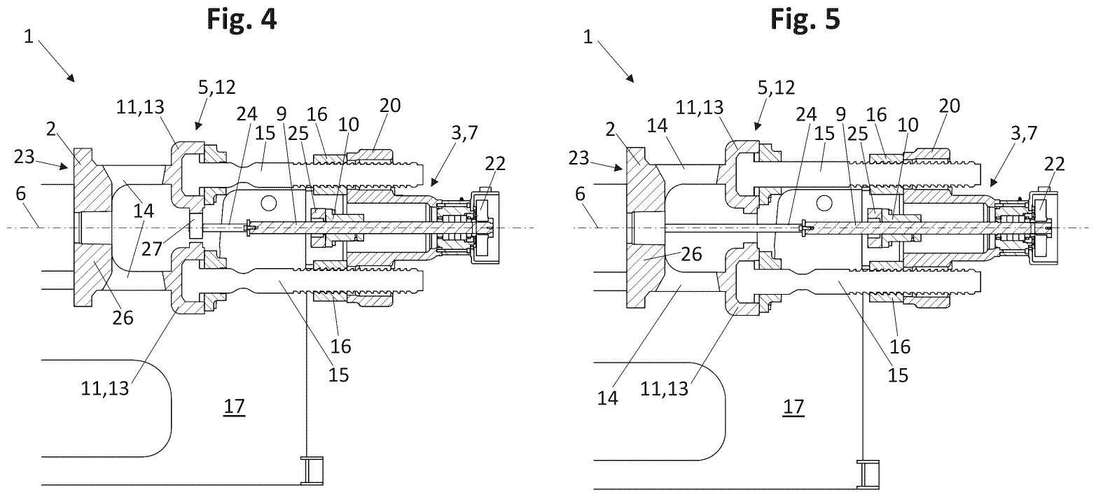

FIG. 4 shows a further exemplary embodiment of a closing unit 1, which is similar to the embodiment of FIGS. 1 and 2 on a larger scale.

In the exemplary embodiment of FIG. 4 of the closing unit 1, however, the pressure pads 11 are not connected to each other, but are merely mounted against each other via the strut 14 of the movable mold mounting plate 2.

A yoke 27 is formed on one of the pressure pads 11, which yoke 27 extends in the direction of the central longitudinal axis 6. The fast-stroke device 3 is connected to this yoke 27 via the link rod 24.

FIG. 5, on the other hand, shows an embodiment of a closing unit 1 in which the pressure pads 11 are completely decoupled from each other and are only connected to each other via the strut 14 and the movable mold mounting plate 2. In this exemplary embodiment, the fast-stroke device 3 is connected via the link rod 24 to a front base body 26 of the movable mold mounting plate 2, which front base body 26 forms the mounting surface 23. The link rod 24 is connected to a side of the base body 26 of the movable mold mounting plate 2 facing away from the mounting surface 23.

The remaining features of the exemplary embodiments of FIGS. 4 and 5 essentially correspond to those of the exemplary embodiment of FIGS. 1 and 2.

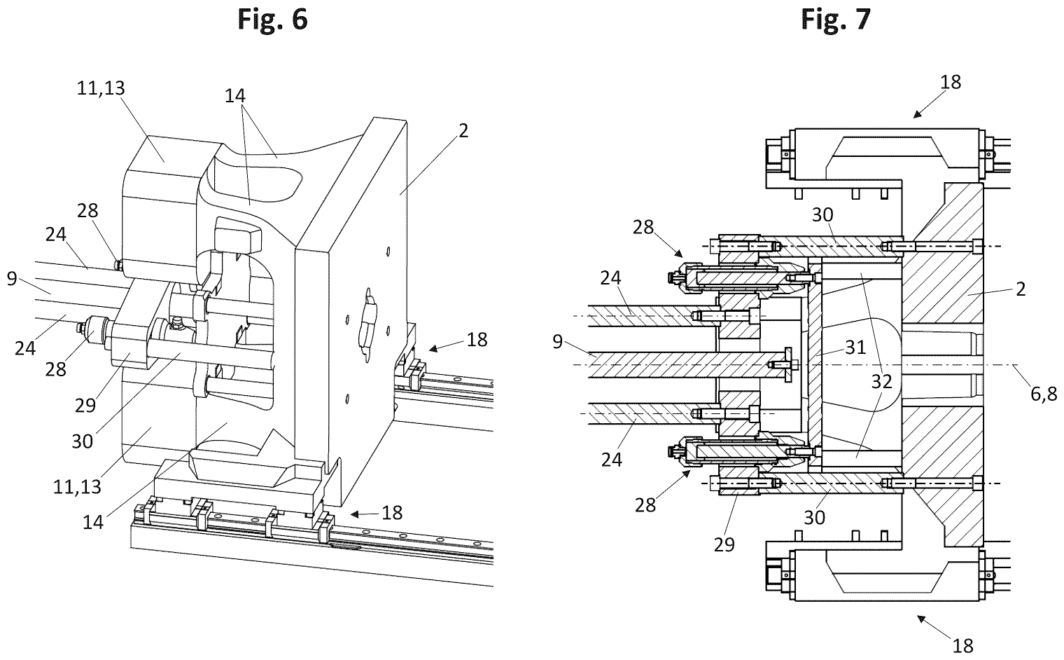

FIG. 6 shows a further exemplary embodiment of a movable mold mounting plate 2 designed as a machine element. The exemplary embodiment shown in FIG. 6 is shown in a sectional view in FIG. 7. In this exemplary embodiment of FIGS. 6 and 7, the link rods 24 of the fast-stroke device 3 known from the previous figures are attached to an additional fast-stroke element 29. Strictly speaking, the link rods 24 are rigidly connected to the fast-stroke element 29 via a screw connection, whereby the translational movement of the fast-stroke device 3 or of the spindle drive 7 is transmitted directly to the fast-stroke element 29. The fast-stroke element 29 is screwed to the movable mold mounting plate 2 by means of the connecting rods 30, whereby this fast-stroke movement is passed on to the movable mold mounting plate 2.

By providing this fast-stroke element 29, a construction space can be created centrally behind the movable mold mounting plate 2, which in this exemplary embodiment serves to accommodate the ejector drive 28.

The ejector columns 32 serve to eject a formed workpiece from the mold after forming. In order to carry out this ejection movement, it is necessary to drive the ejector columns 32 linearly along their longitudinal axis. This linear movement of the ejector columns 32 attached to the ejector plate 31 is implemented by the ejector drives 28 designed as a hydraulic piston-cylinder unit. These ejector drives 28 are supported by the cylinders of the piston-cylinder units on the fast-stroke element 29.

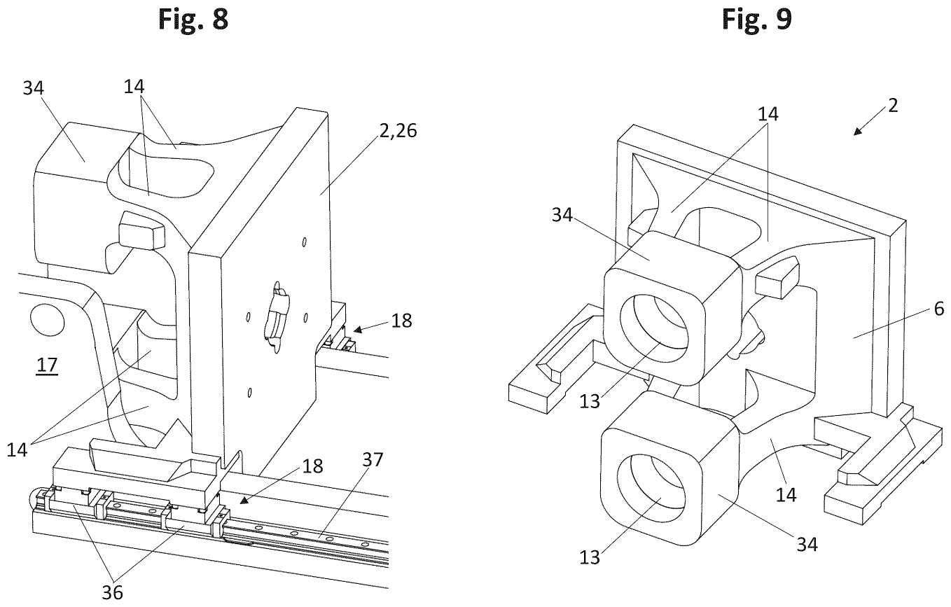

Furthermore, the movable mold mounting plate 2 of this exemplary embodiment is implemented as a machine element, with the precise properties of this machine element or of the movable mold mounting plate 2 being discussed with reference to FIGS. 8 to 12.

FIG. 8 shows the movable mold mounting plate 2 in a perspective view in isolation on the machine frame 17.

FIG. 9 shows a further perspective view of this exemplary embodiment of the movable mold mounting plate 2 in isolation.

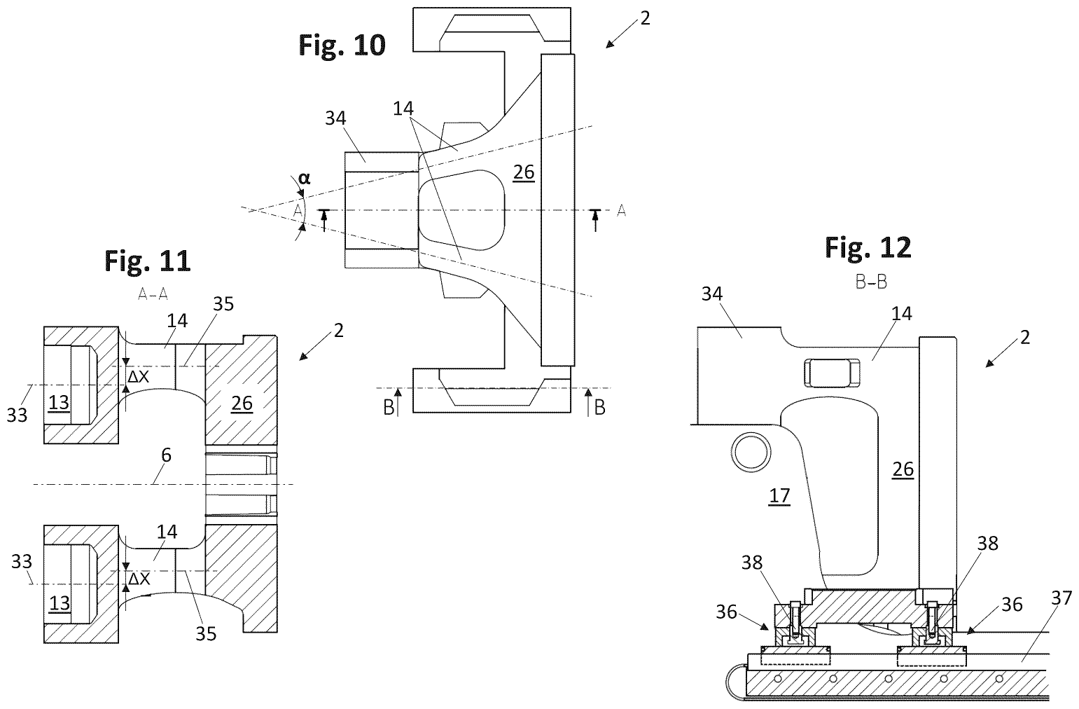

FIG. 10 shows a plan view of the exemplary embodiment of the movable mold mounting plate 2 from FIGS. 8 and 9.

FIGS. 11 and 12 show the sections marked in FIG. 10, with FIG. 11 showing section A-A and FIG. 12 showing section B-B.

This embodiment of the movable mold mounting plate 2 designed as a machine element for mounting a mold comprises a plate-shaped base body 26. This plate-shaped base body 26 is connected to the pressure pad elements 34 via the struts 14. The pressure pad elements 34 in this exemplary embodiment are implemented from pressure pad housings which support the cylinder 13 of the hydraulic piston-cylinder unit, which function as pressure pad 11. Each of the two pressure pad elements 34 is connected to the base body 26 of the movable mold mounting plate 2 via two struts 14. The movable mold mounting plate 2 is formed in one piece with the plate-shaped base body 26, the struts 14 and the pressure pad elements 34. The struts 14 comprise a strut longitudinal axis 35 (see FIG. 10 or 11). The two struts 14, each of which connects a pressure pad element 34 to the base body 26, enclose an angle α with each other.

Furthermore, it can be seen that the longitudinal axis 33 of the pressure pad element 34 has a strut point offset ΔX to the strut longitudinal axes 35 of the struts 14 (see FIG. 11). This strut point offset ΔX is deflected in the same direction for the two pressure pad elements 34.

Furthermore, it can be seen that the struts 14 are symmetrical in a view transverse to the strut longitudinal axis 35 (see FIG. 11), wherein each of the struts 14 has a first contour which is substantially straight and a second contour which is curved, more precisely, has an ellipsoidal curvature.

Furthermore, it can be seen in FIG. 11 that the struts 14 with their strut longitudinal axes 35 are arranged asymmetrically to the central longitudinal axis 6. By means of a corresponding arrangement, for example, ideally taking into account the deformations, a parallelism of the mold mounting plates (in particular the mounting surfaces 23 of the movable mold mounting plate 2 relative to the fixed mold mounting plate 3) can be achieved during a closing force build-up and an opening of the mold can be counteracted.

Ideally, in this exemplary embodiment, one of the strut longitudinal axes 35, in particular the strut longitudinal axes 35 of the strut 14 further away from the machine frame 17, has a distance from the central longitudinal axis 6 that is greater by a value between 1% and 10%, preferably between 2.5% and 7.5%, particularly preferably 5%.

All these measures of offsetting the curvatures and straightness are selected accordingly in order to convert deformations of the closing unit, or more precisely of the machine frame 17 and the movable mold mounting plate 2, as far as possible into elastic deformations of the struts 14, so that plate parallelism and mold closure are not influenced or are influenced only to a small extent.

As can be seen from FIG. 12, the movable mold mounting plate 2 comprises two guide shoes 36 on each side, which are offset from one another along the longitudinal axis 6. These guide shoes 36 are guided on the guide rail 37, which guide rail 37 is in turn connected to the machine frame 17 of the closing unit 1. When a closing force is now built up, the C-shaped machine frame 17 is deformed, which also deforms the guide rails 37. As a result, the movable mold mounting plate 2 is lifted in the front and partially in the rear region.

The guide shoes 36 are connected to the movable mold mounting plate 2 via guide bolts 38. These guide bolts 38 allow a translational movement between the guide shoe 36 and the movable mold mounting plate 2, whereby when the movable mold mounting plate 2 is lifted, no damage to the guide shoes 36 or the guide rail 37 occurs, while nevertheless ensuring that the movable mold mounting plate 2 is secured in position relative to the guide shoes 36.

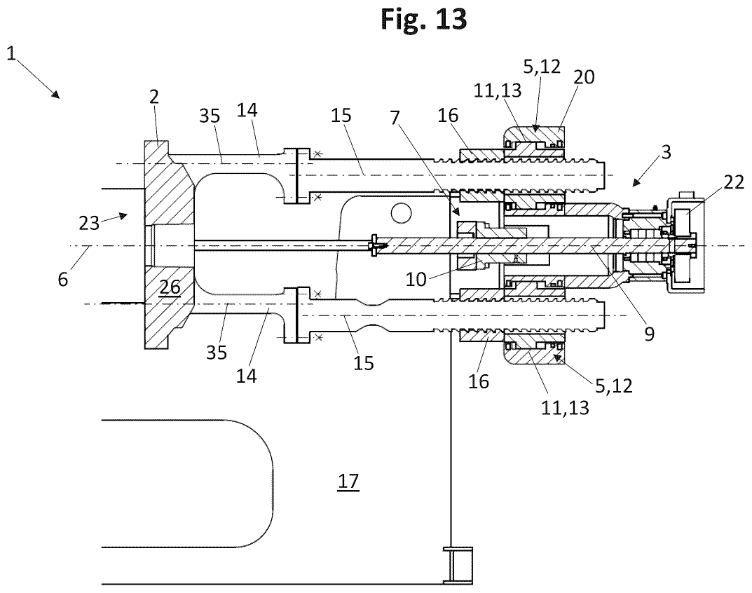

FIG. 13 shows a further embodiment variant of a closing unit 1, which, compared to FIG. 1, comprises a “reverse” arrangement of the closing force mechanism 5 comprising the push rods 15, the locking nuts 16 and the pressure pads 11. In this exemplary embodiment of FIG. 13, the push rods 15 are directly coupled to the struts 14 by a screw connection.

The locking nuts 16 cooperating with the push rods 15 are connected to the support plate 20 via the closing force mechanism 5. In this exemplary embodiment, the support plate is also screwed to the machine frame 17.

The pressure pads 11 of the closing force mechanism 5 are arranged within corresponding bores of the carrier plate 20 and are designed to build up a relative movement and/or a closing force between the carrier plate 20 and the locking nuts 16 in order to build up the closing force, which relative movement and/or closing force is/will in turn be passed on to the movable mold mounting plate 2 via the push rods 15. The pressure pads 11 are implemented as a piston-cylinder unit 12, wherein the cylinder 13 of these piston-cylinder units 12 is formed by the support plate 20 (in particular corresponding recesses of the support plate 20).

The remaining components of the exemplary embodiment of FIG. 13 essentially correspond to those of the exemplary embodiment of FIG. 1.

### LIST OF REFERENCE NUMERALS

1 closing unit
2 movable mold mounting plate
3 fast-stroke device
4 fixed mold mounting plate
5 closing force mechanism
6 central longitudinal axis
7 spindle drive
8 axis of rotation
9 spindle
10 recirculating ball nut
11 pressure pad
12 piston-cylinder unit
13 cylinder
14 strut
15 push rod
16 locking nut
17 machine frame of the closing unit
18 sliding guide of the movable mold mounting plate
19 mold
20 support plate
21 electric drive unit
22 gear
23 mounting surface
24 link rod
25 link bridge
26 base body
27 yoke
28 ejector drive
29 fast-stroke element
30 connecting rods
31 ejector plate
32 ejector columns
33 longitudinal axis of the pressure pads
34 pressure pad element
35 strut longitudinal axis
36 guide shoe
37 guide rail
38 guide bolt
α angle
ΔX strut point offset

1. A closing unit for a molding machine, comprising:
a movable mold mounting plate,
a fast-stroke device which is designed to displace the movable mold mounting plate relative to a fixed mold mounting plate, and
a closing force mechanism separate from the fast-stroke device which is designed to build up a closing force between the fixed mold mounting plate and the movable mold mounting plate,
wherein the fast-stroke device is arranged substantially coaxially to a central longitudinal axis of the closing unit.

2. The closing unit according to claim 1, wherein the fast-stroke device has a, preferably hydraulic, piston-cylinder unit, wherein a cylinder of the piston-cylinder unit is arranged substantially coaxially to the central longitudinal axis.

3. The closing unit according to claim 1, wherein the fast-stroke device has a spindle drive, wherein a rotation axis of a spindle and/or a recirculating ball nut of the spindle drive is arranged substantially coaxially to the central longitudinal axis.

4. The closing unit according to claim 3, wherein the spindle drive is supported on the one hand on a machine frame of the closing unit and on the other hand on a fast-stroke element, which fast-stroke element is preferably connected to the movable mold mounting plate by means of connecting rods.

5. The closing unit according to claim 4, wherein at least one ejector drive is connected to the fast-stroke element, which ejector drive preferably comprises at least one hydraulic piston-cylinder unit.

6. The closing unit according to claim 1, wherein the closing force mechanism has at least two pressure pads, wherein the pressure pads are arranged symmetrically to the central longitudinal axis.

7. The closing unit according to claim 4, wherein, viewed in a plane transverse to the longitudinal axes of the two connecting rods and/or the axes of movement of the two pressure pads, the longitudinal axes and the axes of movement form the corner points of a rhombus.

8. The closing unit according to claim 6, wherein the at least two pressure pads are designed as hydraulic piston-cylinder units, wherein the cylinders of the piston-cylinder units are formed integrally with the movable mold mounting plate.

9. The closing unit according to claim 1, wherein the closing force mechanism, preferably at least one of the at least two pressure pads, particularly preferably at least one of the at least two cylinders of the at least two pressure pads, is connected by means of at least one strut to a partial region of the movable mold mounting plate forming a mounting surface.

10. The closing unit according to claim 9, wherein each of the at least two pressure pads is connected by means of at least one strut to a partial region of the movable mold mounting plate forming a mounting surface, wherein the struts each have a strut longitudinal axis, which preferably run parallel in a view transverse to the central longitudinal axis.

11. The closing unit according to claim 10, wherein the strut longitudinal axes are arranged asymmetrically relative to the central longitudinal axis in a view transverse to the central longitudinal axis, in particular wherein the strut longitudinal axes of the strut further away from the machine frame have a distance that is between 1% and 10%, preferably between 2.5% and 7.5%, particularly preferably 5%, greater from the central longitudinal axis.

12. The closing unit according to claim 1, wherein at least two subcomponents of the closing force mechanism, preferably at least two pressure pads of the closing force mechanism, particularly preferably at least two cylinders of the at least two pressure pads, are connected to one another via a yoke, in particular spaced apart from a partial region of the movable mold mounting plate forming the mounting surface.

13. The closing unit according to claim 6, wherein the fast-stroke device is connected, preferably via a connection to a yoke, to at least one of the at least two cylinders of the at least two pressure pads.

14. The closing unit according to claim 6, wherein the at least two pressure pads, in particular each of the at least two pressure pads, cooperate with a push rod, which push rod is preferably supported on a machine frame of the closing unit via a locking nut.

15. The closing unit according to claim 1, wherein the machine frame of the molding machine is designed as a C-frame on which the movable mold mounting plate is movably mounted by means of a sliding guide.

16. The closing unit according to claim 1, wherein the closing unit is designed as a column-free closing unit and/or 2-plate closing unit.

17. A molding machine, in particular an injection molding machine, comprising the closing unit according to claim 1.
